(19) United States
(12) Patent Application Publication
(10) Pub. No.: US 2013/0055963 A1
(43) Pub. Date: Mar. 7, 2013

(54) Grooming tool for pets

(71) Applicant: Esin Salter, Sunnyvale, CA (US)

(72) Inventor: Esin Salter, Sunnyvale, CA (US)

(73) Assignee: Trufeet LLC, Sunnyvale, CA (US)

(21) Appl. No.: 13/225,529

(22) Filed: Sep. 5, 2011

(51) Int. Cl. A01K 13/00

(52) U.S. Cl. 119/601; 119/600

(57) ABSTRACT

The present invention provides a tool for grooming pets 100, said tool comprising a glove 102 suitable for wearing on human hand and at least one piece of substrate sheet 106 attached to the glove. Also, the tool comprises at least one array of directional hooks 108 attached to the substrate sheet 106. The present invention also provides a method for grooming pets, which comprises placing a hand inside a grooming tool 100 and comprising and petting pet's fur coat with arrays of hooks 108 of said tool.

### FIELD OF THE INVENTION

This invention relates to grooming, and more particularly to a grooming method and tools.

### BACKGROUND OF THE INVENTION

This invention relates to pet grooming aids and more particularly to a grooming method and tools.

Grooming and self-grooming is a typical behavior seen in animals, pets, and birds. Through grooming activities, pets regularly clean themselves and put their fur, feathers or other skin coverings in good order. Pets also engage in social grooming, in which pets in a group clean or maintain one another's fur, feathers or other skin coverings in order to bond with each other and express friendliness. Another result of grooming in pets is the alignment of hairs and feathers, which helps them retain heat and keep out the cold. Cats, thanks to evolutionary process, have developed highly specialized tongues containing dense arrays of small hooks that are feline's primary grooming tool for removing dirt, debris, and aligning hairs. Cats find grooming so important that they spend up to ⅓ of their waking hours on grooming their coat and coats of their cat companions with hook-covered tongues. This grooming behavior of cats is vital to their hygiene, health, and psychological comfort.

It is useful to owners of pets to have a grooming tool, which closely mimics natural tongue grooming action observed in pets' behavior. During the usage of bio-mimicking grooming tool on pets, pets would feel relaxed and pleased as if they were groomed by other pets, which would increase the social bond between the pet and pet owner. To accomplish a similar effect to pet grooming with a man-made tool, their grooming surface of such tool has to bio-mimic pet's natural grooming tool-tongue's surface.

The most common existing grooming tools used for grooming include brushes, gloves, scratching surfaces, and combs. These tools use bristles, metal sticks, or rubber surfaces and don't mimic natural grooming action of pets tongues. Some of the drawbacks of the existing tools include scratching pet's skin with sharp and/or pointy edges, leaving bruises, pulling healthy hair together with dead and loose hair, and causing pets to get upset due to the rough nature of tools used. As a result, pets often try to avoid being groomed by these tools and must be held in place forcefully during grooming.

In conclusion, the existing tools do not have a feel similar to pet's tongues and do not produce grooming results similar to pets' tongues, which makes it harder for pet owners to groom pets and makes the grooming experience generally unpleasant or painful to pets.

### SUMMARY OF THE INVENTION

This invention describes a grooming tool that bio-mimics grooming action of cat's tongue. The grooming surface of the tool is very similar to the grooming surface of cat's tongue. Because the device closely reproduces pet grooming, the resulting effects of grooming with the tool are also similar to the effects of grooming observed in pets. It was noticed that during grooming cat's fur with the present grooming tool, loose cat hair and dirt were removed from cat's coat and the coat became clean and shiny. Also, cats would become very friendly towards the grooming person, very relaxed, soothed, and pleased with the tool grooming action and would often purr. Therefore, there were two types of positive effects: esthetical and psychological. By comparison, the grooming devices on the market, brushes, gloves, scratching surfaces, and combs, are not pleasant to animals. They scratch pet's skin with sharp and/or pointy edges, leave bruises, pull healthy hair together with dead and loose hair, and cause pets to get upset due to the rough nature of tools used. By bio-mimicking, cat's tongue surface with the tool in the present invention, the user can provide an effective grooming action, gentle, pleasant and relaxing experience superior to existing tools in the market, while also bonding with his/her pet.

The present invention provides a tool for grooming pets, said tool comprising a glove suitable for wearing on human hand, at least one piece of substrate sheet attached to outer palm side of the glove, and at least one array of single direction hooks or dual direction double hooks attached to the substrate sheet. The tool may optionally include an array of sticks attached to the substrate sheet in such way that stick ends are in contact or almost in contact with hook ends. The glove of the present invention may be washable and reusable. The glove may be a mitt. The glove may be made out of flexible material, while the substrate sheet and arrays of hooks and sticks may be made out of elastic polymer or made out of plant based or pet fur material. Additionally, the substrate may be attached to the glove with adhesive or may be sewn to the glove or may be attached to the glove via ultrasound wave or microwave heating. The direction of hooks on the substrate of the present invention is preferably not parallel to the direction defined by the glove's index finger. Alternatively, the glove used may be fingerless or with reduced finger length.

This invention also provides a method for grooming pets, which comprises placing a hand inside a grooming tool comprising a glove or mitt suitable for wearing on human hand, at least one piece of substrate sheet attached to outer palm side of the glove or of the mitt, at least one array of single direction hooks or dual direction double hooks attached to the substrate sheet, and optionally an array of sticks attached to the substrate sheet in such way that stick ends are in contact or almost in contact with hook ends.

In an alternative embodiment, the present invention provides a tool for pet grooming, said tool comprising a layer of durable material, at least one piece of substrate sheet attached to said layer, at least one array of single direction hooks or dual direction double hooks attached to the substrate sheet. The tool may optionally include an array of sticks attached to the substrate sheet in such way that stick ends are in contact or almost in contact with hook ends. The layer may made out of plastic, elastic polymer, metal, or wood. The substrate sheet and arrays of hooks and sticks may be made out of elastic polymer. The substrate sheet and arrays of hooks and sticks may be made out of plant based or pet fur material. The substrate may be attached to the layer with adhesive or double-sided adhesive tape, or with hook and loop fasteners with adhesive backing. The tool is meant for attaching to a stationery object or to a handle suitable for holding by human hand. The layer may be attached to a wall, a pole, or another stationary object with a set of screws, glue, double-sided adhesive tape, or hook and loop fasteners with adhesive backing. The tool may further include a handle suitable for holding by human hand. The layer may be attached to a handle with a screw, screws, adhesive, glue, or a handle may be molded together with the layer as one piece.

### SUMMARY DESCRIPTION OF THE DRAWINGS

FIG. 1 is a schematic view of the front and back side of the tool of the present invention

FIG. 2A, 2B, 2C, and 2D are schematic profiles of some possible arrangements of the substrate, hooks, and sticks

FIGS. 3, 4 and 5 are schematic views of other embodiments of the tool of the present invention

### DETAILED DESCRIPTION OF THE INVENTION

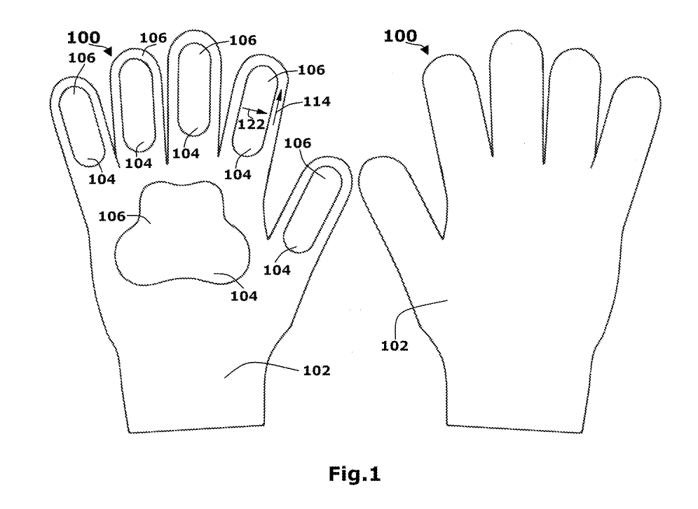

The present invention is a grooming tool 100 in FIG. 1, which is meant for putting on human hand. For the purpose of illustrating the invention, the drawings show a form of the invention that is presently preferred. However, it should be understood that the present invention is not limited to the precise arrangements and instrumentalities shown in the drawings.

The tool 100 permits its users to efficiently groom pet's fur, while providing a pleasant experience to the pet being groomed, such experience being similar to the grooming with tongue occurring among pets.

This tool contains a glove 102 suitable for wearing on human hand and at least one piece of substrate sheet 106 attached to the glove. Also, the tool comprises at least one array of directional hooks 108 attached to the substrate sheet 106. Double hooks 110 and sticks 112 may also be attached to the substrate 106. In the present invention, grooming pads 104 are defined as comprised of substrate sheet 106 and attached to it arrays of hooks 108, and optionally double hooks 110, and sticks 112.

The substrate 106 is thin enough to be flexible. Attached to it are at least one array of single hooks 108 or double hooks 110 for capturing loose hair, dirt and debris and, optionally, an array or arrays of sticks 112, having stick ends 118 in vicinity or in contact with hook ends 116 for better retention of captured hair, dirt and debris.

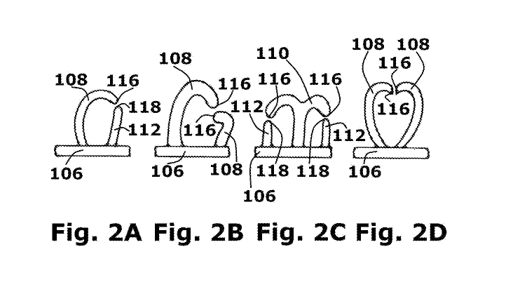

The grooming pad 104 is designed to bio-mimic cat's tongue with a purpose of providing an ideal gentle, pleasant, and relaxing grooming experience for cats and other pets, while improving fur's appearance and shininess. Cat's tongue surface contains an array of hooks 108 or 110 with hook heights varying from 1/32 of inch to 3/16 of inch depending on cat type. Similarly the grooming pads 104 of this invention contain arrays of hooks 108 or 110 with preferable hook heights in a range from 1/32 of inch to 3/16 of inch. Hook heights above and below this range were also tried on cats, and proved to work well, but with some disadvantages. Shorter hooks were not collecting loose hair as efficiently, while longer hooks were creating and leaving lines on cat's fur and providing less gentle grooming action. Nevertheless, the hook height outside of the range from 1/32 of inch to 3/16 of inch can work well on pets other than cats. It is also critical that hooks 108 and 110, sticks 112, and substrate 106 to which the hooks and sticks are attached be elastic to avoid scratching pet's skin during grooming. The actual shape of hooks 108 and 110 can vary without making significant difference on grooming. Hooks may start vertically from where they connect to substrate 106 or they may start at an angle. They may also have tighter or wider hook endings. Some of possible hook and stick topologies are shown in FIG. 2A, 2B, 2C, and 2D. Based on these grooming pad requirements, articles available on the market that fit well these required properties of substrate 106, hooks 108 and 110, and sticks 112 are products made out of elastic polymers, which are commercially available from multiple manufacturers under the name of hooks in hook and loop products. Since these hook products are typically manufactured in the form of tapes of various lengths and widths, the desired shapes of substrate 106 used for this grooming tool have to be cut out from these tapes. When these hook products were used for testing the present tool, they provided excellent results. The cats tested were enjoying the grooming experience and it was observed that they would often purr loudly and follow the grooming person to be further petted with the tool. This was an important result proving the usefulness of the tool as cats typically avoid grooming due to rough nature of grooming brushes or rubber gloves. Also, the tool produced a lustrous, silky and smooth fur coat, while removing loose hair, dirt, and debris.

The grooming pads 104 can be of various shape and number. Small, numerous grooming pads 104 can be used to increase the flexibility of the tool, while large, few grooming pads can be used to simplify the manufacturing process by reducing the number of pieces that need to be assembled. In the preferred embodiment of FIG. 1, six grooming pads 104 are shown as a compromise between tool flexibility and manufacturing assembly. Each grooming pad 104 needs to be connected to the glove 102 during the production. To accomplish this, there are many solutions including but not limited to sewing, gluing, microwave heating, or ultrasound heating.

An important aspect of this invention is that the retained dirt, loose hair, and debris on active grooming surface 104 of the tool can be easily cleaned in 3 ways allowing for a continuous reuse of the tool and providing more value to the user. First, the tool is machine washable. Second, the cleaning can be done by placing the tool on hard surface and brushing a rigid comb across the grooming pad 104. Third, the grooming pad 104 can be cleaned with a sticky lint roller.

An alternate solution to glove 102 may be a fingerless glove or a glove with cut off tips on each finger. In this case, stroking pet's fur provides both grooming and direct petting with user's hand where fingers are exposed.

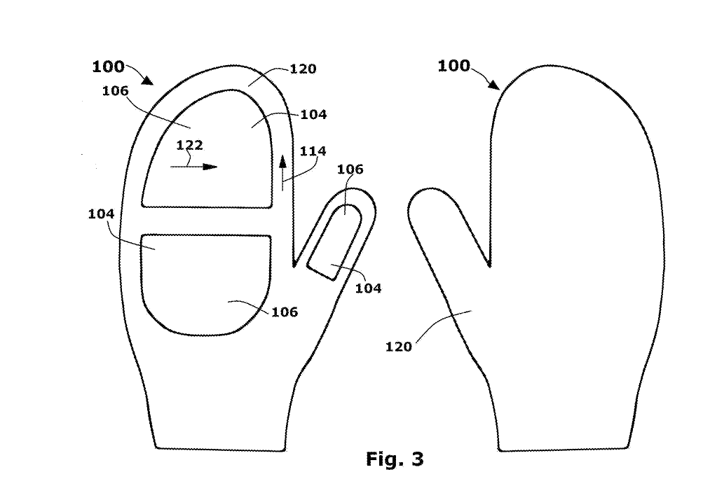

Another alternative solution is to use a glove that is a mitt 120 as shown in FIG. 3. The glove 102 or mitt 120 used in manufacturing this grooming tool is made out of flexible material to ensure both comfort on user's hand and gentle grooming action on pet's fur. Rigid materials are not recommended, as they would not contour to pet's shape during petting. Some possible flexible materials used may be cotton, a combination of cotton and polyester, a combination of cotton, polyester, and rayon, or a mix of natural and synthetic materials. A glove or mitt may also be made out of waterproof mesh, such as elastic polymer may provide, in order to make the tool usable for pet grooming during bathing. While the tool based on using a mitt 120 was producing desirable grooming effects, the tool using a glove 102 was more pleasant to cats, as humans using the tool may better contour the glove's 102 active grooming surfaces 104 to pet's shape. Also, the glove 102 allowed for more efficient grooming of small areas such as paws and face.

The grooming process claimed in this invention requires that a user puts on the glove 102 and pets fur coat of a pet with arrays of hooks 108 or 110 of the tool. The grooming action during the petting step is dependent on the orientation 122 of hooks 108 and 110. Since, typically, users pet animals by moving hand from left to right or from right to left, the orientation 122 of hooks 108 and 110 favorable to capturing loose hair, dirt, and debris corresponds to the direction of tool movement during such petting action. In other words, the favorable orientation 122 of hooks 108 and 110 is non-parallel and generally perpendicular to the direction pointed by the user's index finger 114. To accommodate for both directions of user's hand, i.e. from left to right and from right to left, two arrays of hooks 108 or 110 can be used with opposed directionality.

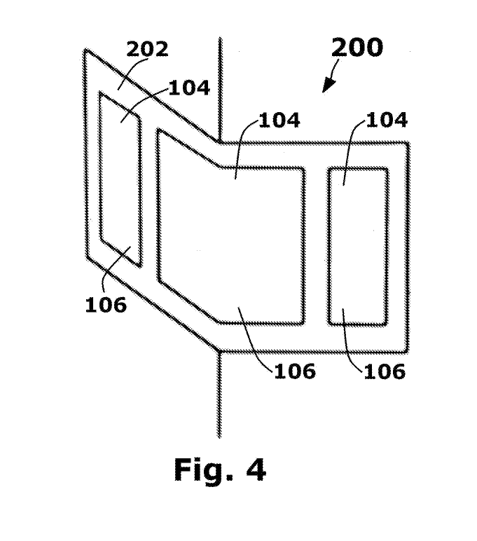

While the tool 100 allows a user to groom a pet, an alternative embodiment 200 in FIG. 4 provides a pet-grooming tool whereby the pet can groom itself without user's help. The tool 200 is relying on the same grooming pad 104 presented as part of the tool 100. This grooming pad 104 is similarly meant for bio-mimicking cat's tongue surface and shares a lot of advantages with tool 100 including efficient grooming of pet's fur, gently removing loose hair, and providing pleasant and relaxing grooming experience.

The tool 200 contains a durable layer 201, at least one grooming pad 104 comprising thin enough substrate 106 to be flexible, with, attached to it, at least one array of single hooks 108 or double hooks 110 for capturing loose hair, dirt and debris and, optionally, an array or arrays of sticks 112, having stick ends 118 in vicinity or in contact with hook ends 116 for better retention of captured hair, dirt and debris. As in the case of the tool 100, there may be one or more grooming pads 104 and their shapes may be decided based on esthetics reasons. If the tool 200 is placed around the corner of the wall as shown in FIG. 4, it is desirable to have grooming pads placed across the edge where the two walls come together, since cats are especially attracted to edges of objects. The grooming pads 104 may attach to the layer 201 via permanent gluing by using permanent glue. If it is desirable to detach grooming pads 104 for the purpose of washing them or for the purpose of replacing them with new grooming pads or grooming pads of different characteristics (shape, number, color, hook height, hook density, etc.), then a double-sided adhesive tape or hook and loop fasteners with adhesive backing can be used as the attachment between the layer 201 and grooming pads 104. The adhesive side of hook and loop fasteners would attach to layer 201 and areas 104 respectively in such a way that hook and loop sides would be in alignment and may be fastened to each other.

Grooming pads 104 may be positioned in such way that orientation 122 of hooks of each area be different to account for possible directions of grooming that a pet might pick during self-grooming with the tool 200. For example, the orientation 122 of hooks 108 and 110 may be as follows: central grooming pads 104 in FIG. 4—horizontal to ground, left hand side grooming pads 104 vertical to ground, right hand side grooming pads 104 at 45 degree angle to ground.

The layer 201 is attachable to a wall, a leg of a chair or table or another stationary object large enough to ensure that a pet would not be able to displace such object during self-grooming with tool 200. The means for the attachment to these stationary objects may be a glue. Alternatively, screws passing through layer 201 and screwed into the object may replace the glue. If it is desirable that the tool 200 be easily detachable from the object, double-sided adhesive tape or hook and loop fasteners with adhesive backing can be used in place of the glue.

It is advantageous that the surface 201 be made out of durable material that does not tear easily, since the user might be often replacing grooming pads 104 hence applying tensile stress during the detachment of double-sided adhesive tape or hook and loop fasteners joining the layer 201 and the grooming pads 104. Some of the durable materials appropriate for this layer are metal, plastic or wood. Metal and plastic are preferable if the tool 200 needs to wrap around an object that is not flat.

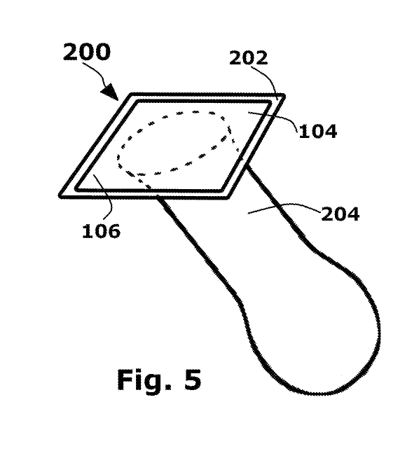

An alternative embodiment of tool 200 is shown in FIG. 5. This alternative embodiment shares elements and interconnectivity of tool 200 described above, but the durable layer is in this case attached to a handle 220 suitable for holding by human hand to allow the tool 200 to be used by a human. Hence, the tool assembled in such a way is a brush. It is preferable that the handle 220 be made of durable and inflexible material to ensure the rigidity of the brush during grooming. Some possible materials may be wood, plastic or metal. The shape of the handle may vary and some options may be that handle be cylindrical or be more ergonomic and nearly cylindrical having its cross section increase in area towards the middle of the handle as shown in FIG. 5.

The descriptions and illustrations of the present grooming tool, including sizes, colors, shapes, dimensions, materials, and arrangements of shapes, are used to provide examples of the tool, rather than limitations in constructing the tool. Different sizes, shapes, dimensions, materials, and arrangements of shapes and modifications can be used, while still meeting the requirements and advantages of the grooming tool presented in the summary and detailed description sections.

What is claimed is:

1. A tool for grooming pets, said tool comprising:
a. A glove suitable for wearing on human hand
b. At least one piece of substrate sheet attached to the glove
c. At least one array of directional hooks attached to the substrate sheet

2. The tool of claim 1, wherein the tool is washable

3. The tool of claim 1, wherein the glove is made out of flexible material

4. The tool of claim 1, wherein the glove is a mitt

5. The tool of claim 1, wherein the substrate sheet and arrays of hooks and sticks are made out of elastic polymer

6. The tool of claim 1, wherein the substrate sheet and arrays of hooks and sticks are made out of plant based material

7. The tool of claim 1, wherein the substrate is attached to the glove with adhesive

8. The tool of claim 1, wherein the substrate is attached to the glove via ultrasound wave heating

9. The tool of claim 1, wherein the array of sticks is attached to the substrate sheet in such way that stick ends are in contact or almost in contact with hook ends

10. The tool of claim 1, wherein the direction of hooks is not parallel to the direction defined by the glove's index finger

11. The tool of claim 1, wherein the glove is fingerless

12. A method for grooming pets, which comprises
a. Placing a hand inside a grooming tool comprising:
i. A glove or mitt suitable for wearing on human hand
ii. At least one piece of substrate sheet attached to the glove or to the mitt
iii. At least one array of directional hooks attached to the substrate sheet
b. Petting pet's fur coat with arrays of hooks of said tool

13. A tool for pet grooming, said tool comprising:
a. A layer of durable material
b. At least one piece of substrate sheet attached to said layer
c. At least one array of directional hooks attached to the substrate sheet

14. The tool of claim 13, wherein said layer is made out of plastic

15. The tool of claim 13, wherein said layer is made out of wood

16. The tool of claim 13, wherein the substrate sheet and arrays of hooks and sticks are made out of elastic polymer

17. The tool of claim 13, wherein the array of sticks is attached to the substrate sheet in such way that stick ends are in contact or almost in contact with hook ends

18. The tool of claim 13, wherein the substrate is attached to the layer with adhesive tape

19. The tool of claim 13, wherein the substrate is attached to the layer with hook and loop fasteners with adhesive backing

20. The tool of claim 13, further including a handle attached to said layer and suitable for holding by human hand
